(19) United States
(12) Patent Application Publication
(10) Pub. No.: US 2024/0315268 A1
(43) Pub. Date: Sep. 26, 2024

(54) A vegetable fat composition for edible applications

(71) Applicant: AAK AB (PUBL), Malmö (SE)

(72) Inventor: Morten Daugaard ANDERSEN, Højbjerg (DK)

(21) Appl. No.: 18/259,867

(22) PCT Filed: Jan. 11, 2022
(86) PCT No.: PCT/SE2022/050014

§ 371 Date: Jun. 29, 2023

(30) Foreign Application Priority Data
Jan. 27, 2021 (SE) 2150089-7

(51) Int. Cl. A23D 9/00; A23G 1/36; C11C 3/10

(52) U.S. Cl. CPC A23D 9/00; A23G 1/36; C11C 3/10

(57) ABSTRACT

Disclosed is a vegetable fat composition for edible applications. The invention also relates to use of the vegetable fat composition for manufacturing a vegetable fat mixture; a vegetable fat mixture; use of the vegetable fat mixture in coating or enrobing for bakery, confectionary, and/or moulding applications; use of the vegetable fat mixture in fillings, such as bakery fillings and confectionary fillings; or use of the vegetable fat mixture for chocolate or chocolate-like coating; and an edible application product comprising the vegetable fat composition or the vegetable fat mixture.

### TECHNICAL FIELD OF THE INVENTION

The present invention relates to a vegetable fat composition for edible applications. The invention also relates to use of the vegetable fat composition for manufacturing a vegetable fat mixture; a vegetable fat mixture; use of the vegetable fat mixture in coating or enrobing for bakery, confectionery, and/or moulding applications; use of the vegetable fat mixture in fillings, such as bakery fillings and confectionery fillings; or use of the vegetable fat mixture for chocolate or chocolate-like coating; and an edible application product comprising the vegetable fat composition or the vegetable fat mixture.

### BACKGROUND OF THE INVENTION

Fast crystallizing compounds (in traditional terminology Cocoa Butter Substitutes) generally have the disadvantages of a low cocoa butter tolerance, hence cocoa butter substitutes (CBS) are only mixable with cocoa butter in small ratios. This means that fast crystallizing compounds are best suited for recipes with only cocoa powder in order to avoid undesired short shelf life due to rapid bloom formation.

However, there is a risk of cross contamination during production when a product line shift from a compound recipe with cocoa mass to a fast crystallizing compound powder recipe. This cross contamination may result in shortening of the latter compounds shelf life.

There exists a few ways to improve the cocoa butter tolerance for non-temper compounds, such as CBS. WO2017179455A1 describes adding a soft component comprising OStO to a CBS. This has shown to improve the cocoa butter tolerance to a certain degree. However, OStO addition results in a softer compound texture and the increased cocoa butter tolerance obtained so far needs to be improved further, to be able to cope with the cocoa mass contents needed in the recipe to obtain the strong cocoa taste.

WO2017169623 describes a compound fat comprising a vegetable fat component with both short chain (5-15%≤C10) and long chain (2-12%≥C20) fatty acids in the triglycerides. The resultant compounds with up to 20-30 weight % cocoa butter in the fat phase show no bloom after 1 months at 20° C., but the fat seems to be very soft and probably most useful as a filling.

There is therefore still a need within the field to provide a non-temper vegetable fat composition which is suitable for use in both coatings, enrobings and fillings, where the non-temper vegetable fat composition has an improved cocoa butter/cocoa mass tolerance compared to existing non-temper vegetable fat solutions.

Accordingly, the main object of the invention is to provide a non-temper vegetable fat composition, with an improved cocoa butter/cocoa mass tolerance.

Yet another object is to provide a number of applications for such vegetable fat compositions.

### SUMMARY OF THE INVENTION

The present invention relates to a vegetable fat composition for edible applications, wherein the triglycerides in said vegetable fat composition contain randomly distributed fatty acids, and wherein, in said vegetable fat composition the:
a. sum of saturated fatty acids (SAFA) is at least 90% by weight,
b. sum of saturated C20 to C22 fatty acids is at least 13% by weight,
c. sum of saturated C8 to C10 fatty acids is in the range from 2% to 15% by weight, and
d. sum of saturated C12 to C14 fatty acids is at least 30% by weight.

The vegetable fat composition for edible applications of the present invention enables the production of an robust edible application product that has a significantly better cocoa butter/cocoa mass tolerance than existing non-temper vegetable fat solutions. This improved cocoa butter/cocoa mass tolerance results in a list of advantages:
Production line shifts will be easier to handle (e.g from cocoa butter replacer (CBR) with a certain amount of cocoa mass to a CBS system with a lower amount of cocoa mass),
Increased positive customer perception of compound taste by addition of more cocoa butter/cocoa mass to a recipe using CBS,
Increased positive customer perception of compound meltdown by addition of more cocoa butter/cocoa mass to a recipe using CBS,
Increased positive customer perception of compound performance in applications,
Enabling producers to add “Cocoa butter or cocoa mass” on the product label by increasing the tolerance of the product, hereby allowing the producer to add a small amount of cocoa butter/mass to the recipe.

By using the vegetable fat composition as disclosed herein for edible applications, e.g. a compound comprising CBS, the producers of the edible application compounds reduce the risk of blooming of their edible applications compounds due to a to high content of cocoa butter and/or cocoa mass in their compound recipe (either deliberately added or via cross contamination on the production line).

The present invention also relates to the use of a vegetable fat composition for manufacturing of a vegetable fat mixture, wherein the vegetable fat mixture comprises a blend of a vegetable fat composition according to the present disclosure and at least one vegetable fat component.

The present invention further relates to a vegetable fat mixture comprising a vegetable fat composition according to the present disclosure in the amount from 10% to 70% by weight, such as from 20% to 60% by weight, or such as from 25% to 45% by weight and at least one vegetable fat component.

Use of the vegetable fat mixture in coating or enrobing for bakery, confectionary applications, and/or molding applications; or in fillings, such as bakery fillings and confectionery fillings; or for chocolate and chocolate-like coatings is also disclosed herein.

The invention also relates to an edible application product comprising the vegetable fat composition or the vegetable fat mixture according to the present disclosure.

### Definitions

In the context of the present invention, the following terms are meant to comprise the following, unless defined elsewhere in the description.

As used herein, the term “vegetable” shall be understood as originating from a plant or a single cell organism. Thus, vegetable fat or vegetable triglycerides are still to be understood as vegetable fat or vegetable triglycerides if all the fatty acids used to obtain said triglyceride or fat is of plant or single cell organism origin.

As used herein, the term “triglycerides” may be used interchangeably with the term “triacylglycerides” and should be understood as an ester derived from glycerol and three fatty acids. “Triglycerides” may be abbreviated TG or TAG.

Saturated fatty acids are chains of carbon atoms joined by single bonds, with the maximum number of hydrogen atoms attached to each carbon atom in the chain. Unsaturated fatty acids are chains of carbon atoms joined by single bonds and varying numbers of double bonds, which do not have their full quota of hydrogen atoms attached. An unsaturated fatty acid can exist in two forms, the cis form and the trans form. A double bond may exhibit one of two possible configurations: trans or cis. In trans configuration (a trans fatty acid) the carbon chain extends from opposite sides of the double bond, whereas, in cis configuration (a cis fatty acid) the carbon chain extends from the same side of the double bond.

By using the nomenclature CX means that the fatty acid comprises X carbon atoms, e.g. a C14 fatty acid has 14 carbon atoms while a C8 fatty acid has 8 carbon atoms.

By using the nomenclature CX:Y means that the fatty acid comprises X carbon atoms and Y double bonds, e.g. a C14:0 fatty acid has 14 carbon atoms and 0 double bonds while a C18:1 fatty acid has 18 carbon atoms and 1 double bond.

In general, triglycerides use a “sn” notation, which stands for stereospecific numbering. In a Fischer projection of a natural L-glycerol derivative, the secondary hydroxyl group is shown to the left of C-2; the carbon atom above this then becomes C-1 and that below becomes C-3. The prefix ‘sn’ is placed before the stem name of the compound.

### Sn1/sn2/sn3:

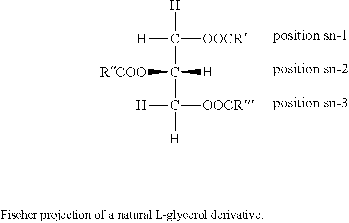

By randomly distributed is meant that the fatty acids is randomly distributed to the three sn-positions. A randomly distributed composition may be obtained by means of esterification, chemical transesterification or enzymatic transesterification. All naturally occurring fat compositions, e.g. virgin olive oil, palm kernel oil, coconut oil or rapeseed oil all have a non-randomly distribution of the fatty acids on the glycerol backbone.

By vegetable fat component is meant a vegetable fat originating from a plant or a single cell organism. The vegetable fat component can e.g. be selected from the group of palm kernel oil, coconut oil, high lauric rapeseed oil, or a blend thereof, and/or fractions thereof. It can also be selected from an interesterified, fractionated, and/or hydrogenated version of palm kernel oil, coconut oil, high lauric rapeseed oil, or a blend thereof, and/or fractions thereof.

As used herein, “%” or “percentage” relates to weight percentage i.e. wt. % or wt.-% if nothing else is indicated.

The sum of a given component in the vegetable fat composition can never be more than 100% by weight, e.g. the sum of all the fatty acid in the vegetable fat composition can never be more than 100% by weight.

As used herein, “oil” and “fat” are used interchangeably, unless otherwise specified.

As used herein, “vegetable oil” and “vegetable fat” are used interchangeably, unless otherwise specified.

As used herein the term “single cell oil” shall mean oil from oleaginous microorganisms which are species of yeasts, molds (fungal), bacteria and microalgae. These single cell oils are produced intracellular and in most cases during the stationary growth phase under specific growth conditions (e.g. under nitrogen limitation with simultaneous excess of a carbon source). Examples of oleaginous microorganisms are, but not limited to, Mortierella alpineea, Yarrowia lipolytica, Schizochytrium, Nannochloropsis, Chlorella, Crypthecodinium cohnii, Shewanella.

As used herein “cocoa butter substitute”, CBS, is intended to mean an edible fat having a triglyceride composition very different to cocoa butter. Most cocoa butter substitutes are based on lauric fats, i.e. fats that contain a high amount of lauric acids in their fatty acid composition. Cocoa butter substitutes are only mixable with cocoa butter in small ratios. Furthermore, cocoa butter substitutes are non-temper fat compositions so in contrast to chocolate, cocoa butter substitute based compounds do not need to undergo a treatment at different temperatures, known as tempering, prior to molding, coating, or enrobing, in order to obtain a final product with acceptable form stability and/or shelf life.

As used herein “edible” is something that is suitable for use as food or as part of a food product, such as a dairy or confectionary product.

For products and methods in the confectionery areas, reference is made to “Chocolate, Cocoa and Confectionery”, B. W. Minifie, Aspen Publishers Inc., 3. Edition 1999.

A food product is a product for human consumption.

By a chocolate or chocolate-like product is meant a product, which at least is experienced by the consumer as chocolate or as a confectionery product having sensorial attributes common with chocolate, such as e.g. melting profile, taste etc. Some chocolate comprises cocoa butter, typically in substantial amounts, where some chocolate-like product may be produced with a low amount of or even without cocoa butter, e.g. by replacing the cocoa butter with a cocoa butter equivalent, cocoa butter substitute, etc. In addition, many chocolate or chocolate-like products comprise cocoa powder or cocoa mass, although some chocolate or chocolate-like products, such as typical white chocolates, may be produced without cocoa powder, but e.g. drawing its chocolate taste from cocoa butter. Depending on the country and/or region there may be various restrictions on which products may be marketed as chocolate.

The term “comprising” or “to comprise” is to be interpreted as specifying the presence of the stated parts, steps, features, or components, but does not exclude the presence of one of more additional parts, steps, features, or components.

As used herein, the term “and/or” is intended to mean the combined (“and”) and the exclusive (“or”) use, i.e. “A and/or B” is intended to mean “A alone, or B alone, or A and B together”.

### DETAILED DESCRIPTION OF THE INVENTION

When describing the below embodiments, the present invention envisages all possible combinations and permutations of the below described embodiments with the above disclosed aspects.

The invention relates to a vegetable fat composition for edible applications, wherein the triglycerides in said vegetable fat composition contain randomly distributed fatty acids, and wherein, in said vegetable fat composition the:
a. sum of saturated fatty acids (SAFA) is at least 90% by weight,
b. sum of saturated C20 to C22 fatty acids is at least 13% by weight,
c. sum of saturated C8 to C10 fatty acids is in the range from 2% to 15% by weight, and
d. sum of saturated C12 to C14 fatty acids is at least 30% by weight.

The vegetable fat composition for edible applications of the present invention has a significantly better cocoa butter/cocoa mass tolerance than existing non-temper vegetable fat solutions in the market. The shelf life of the compounds manufactured using the vegetable fat composition of the present invention is increased compared to a comparative compound and a commercially available compound (see example 4). This improved cocoa butter/cocoa mass tolerance of the vegetable fat composition results in a compound with increased shelf life. In addition to increased shelf life, other advantages such as more robust production line shifts, increased positive customer perception of compound taste by addition of more cocoa butter/cocoa mass, increased positive customer perception of compound meltdown by addition of more cocoa butter/cocoa mass, and increased positive customer perception of compound performance in applications.

The vegetable fat composition for edible applications of the present invention also enables producers to add “Cocoa butter or cocoa mass” on the product label.

One of the benefit for the producer of such edible application compounds is reduction of the risk of blooming of their edible applications compounds due to a to high content of cocoa butter and/or cocoa mass in their compound recipe (either deliberately added or via cross contamination on the production line).

In one or more embodiments, the sum of saturated fatty acids is at least 92% by weight, such as at least 93% by weight, such as at least 95% by weight, such as at least 97% by weight, or such as at least 99% by weight.

In one or more embodiment, the sum of saturated fatty acids is in the range from 90% to 100% by weight, such as in the range from 93% to 100%.

In one or more embodiment, the sum of saturated fatty acids is in the range of from 95% to 100% by weight, such as from 97% to 100% by weight, or such as from 99% to 100% by weight.

In one or more embodiment, the sum of saturated C20 to C22 fatty acids is at least 14% by weight, such as at least 15% by weight, or such as at least 16% by weight.

In one or more embodiment, the sum of saturated C20 to C22 fatty acids is in the range from 13% to 25% by weight, such as in the range from 13% to 22%. In one or more embodiment, the sum of saturated C20 to C22 fatty acids is in the range from 14% to 25% by weight, such as in the range from 15% to 25%, or such as in the range from 16% to 25%. In one or more embodiment, the sum of saturated C20 to C22 fatty acids is in the range from 14% to 22% by weight, such as in the range from 15% to 22%, or such as in the range from 16% to 22%.

In one or more embodiment, the sum of saturated C8 to C10 fatty acids is in the range from 3% to 14% by weight, such as in the range from 4% and 13% by weight, such as in the range from 5% and 12% by weight, such as in the range from 6% and 11% by weight, or such as in the range from 7% and 10% by weight.

In one or more embodiment the sum of saturated C8 and C10 fatty acids is no more than 15% by weight, such as no more than 14% by weight, such as no more than 13% by weight, such as no more than 12% by weight, such as no more than 11% by weight, or such as no more than 10% by weight.

In one or more embodiments, the sum of saturated C12 to C14 fatty acids is at least 35% by weight, such as at least 38% by weight. In one or more embodiments, the sum of saturated C12 to C14 fatty acids is in the range from 30% to 55% by weight, such as in the range from 35% to 50% by weight, or such as in the range from 38% to 50% by weight.

In one or more embodiments, the content of saturated C12 fatty acids is in the range from 20% to 50% by weight, such as from 20% to 45% by weight, or such as from 22% to 38% by weight.

In one or more embodiments, the sum of saturated C16 to C18 fatty acids is at least 20% by weight.

In one or more embodiments, the sum of saturated C16 to C18 fatty acids is in the range from 20% to 45% by weight, such as in the range from 22% to 40% by weight.

In one or more embodiments, the iodine value (IV) of the vegetable fat composition is no more than 4.4.

In one or more embodiments, the iodine value (IV) of the vegetable fat composition is in the range of 0.0 to 4.4. In one or more embodiments, the iodine value (IV) of the vegetable fat composition is in the range of 0.0 to 4.0, such as in the range of 0.0 to 3.5, such as in the range of 0.0 to 3.0, such as in the range of 0.0 to 2.5, such as in the range of 0.0 to 2.0, such as in the range of 0.0 to 1.5, such as in the range of 0.0 to 1.0, or such as in the range of 0.0 to 0.5.

In one or more embodiment, the randomly distributed fatty acids in said vegetable fat composition is obtained by esterification of glycerol with free fatty acids. There are different ways of doing this. One possible way is to mix glycerol and free fatty acids and heat the reaction mixture to 70° C. The reaction mixture is then heated to 170° C. over 30 minutes under reduced pressure of approx. 100-150 mbar and further kept at 170-180° C. for 7 hours where the reduced pressure is lowered stepwise to 33 mbar as reaction time progress. Then the temperature is raised to 210° C. Once the final reaction temperature of 210° C. is reached, the reaction mixture is left for 2 hours. The excess free fatty acids from the obtained crude oil can be distilled of at 240° C. under reduced pressure before the oil can be bleached, filtered, and deodorized.

In one or more embodiment, the randomly distributed fatty acids in said vegetable fat composition is obtained by interesterification or a transesterification of vegetable oil parts, such as a chemically interesterification of vegetable oil parts.

In one or more embodiment, the vegetable oil parts are selected from hydrogenated coconut oil, coconut oil and/or hydrogenated high erucic rapeseed (HEAR) oil.

Interesterification, transesterification e.g. such as chemically interesterification are standard methods known to persons skilled in the art and it is well within the skills of persons skilled in the art to define parameters and conditions to successfully perform the methods.

In one or more embodiments, the vegetable fat composition is not originating from a single cell organism.

The invention also relates to use of a vegetable fat composition for manufacturing of a vegetable fat mixture, wherein the vegetable fat mixture comprises a blend of a vegetable fat composition selected from a vegetable fat composition according to the above disclosure and at least one vegetable fat component.

In one or more embodiment, the at least one vegetable fat component is selected from the group consisting of palm kernel oil, coconut oil, high lauric rapeseed oil, or a blend thereof, and/or fractions thereof, or an interesterified, fractionated, and/or hydrogenated version of palm kernel oil, coconut oil, high lauric rapeseed oil, or a blend thereof, and/or fractions thereof.

In one or more embodiments, the vegetable fat mixture is a CBS. At present, CBS has a low tolerance of maximum 5% of cocoa butter in the fat phase. However, the present invention demonstrate that a CBS with e.g. 10% or 15% cocoa butter in the fat phase can be produced with increased shelf life compared to a comparative compound and a commercially available compound (see example 4). Hence, this improved cocoa butter/cocoa mass tolerance of the vegetable fat composition can result in an increased shelf life of a compound comprising the CBS vegetable fat mixture of the present disclosure.

In one or more embodiment, the obtained vegetable fat mixture comprises from 10% to 70% by weight of the vegetable fat composition, such as from 20% to 60% by weight, or such as from 25% to 45% by weight.

The present disclosure also comprise a vegetable fat mixture comprising a vegetable fat composition according to the present disclosure in the amount from 10% to 70% by weight, such as from 20% to 60% by weight, or such as from 25% to 45% by weight and at least one vegetable fat component.

In one or more embodiments, the obtained vegetable fat mixture consist of the vegetable fat composition and the vegetable fat component. This means that if the vegetable fat mixture comprises the vegetable fat composition in 60% by weight, then the remaining 40% by weight in the vegetable fat mixture is the at least one vegetable fat component, hereby giving a total 100% by weight mixture.

In one or more embodiments, the vegetable fat mixture is a CBS.

In one or more embodiment of the vegetable fat mixture, the at least one vegetable fat component is selected from the group consisting of palm kernel oil, coconut oil, high lauric rapeseed oil, or a blend thereof, and/or fractions thereof, or an interesterified, fractionated, and/or hydrogenated version of palm kernel oil, coconut oil, high lauric rapeseed oil, or a blend thereof and/or fractions thereof.

In one or more embodiment of the vegetable fat mixture, the solid fat content (SFC) at 20° C. is above 70. In one or more embodiments of the vegetable fat mixture, the SFC at 20° C. is above 75, such as above 80, or such as above 85.

Solid fat content (SFC) is a measure of the percentage of fat in crystalline (solid) phase to total fat (the remainder being in liquid phase) at a specific temperature or temperature range, measured across a temperature gradient.

In one or more embodiment of the vegetable fat mixture, the solid fat content (SFC) of the vegetable fat composition is measured by IUPAC 2.150a.

In one or more embodiment of the vegetable fat mixture, the SFC at 40° C. is less than 2.5, such as less than 2.0, such as less than 1.5, such as less than 1.0, or such as less than 0.5.

Also disclosed herein is the use of the vegetable fat mixture according to the present disclosure in coating or enrobing for bakery, confectionery, and/or molding applications.

Also disclosed herein is the use of the vegetable fat mixture according to the present disclosure in fillings, such as bakery fillings and confectionery fillings.

Also disclosed herein is the use of the vegetable fat mixture according to the present disclosure for chocolate and chocolate-like coatings.

The present invention also discloses an edible application product comprising the vegetable fat composition according to the present disclosure or the vegetable fat mixture according to the present disclosure.

The edible application product is a non-temper product, having a better shelf life compared to a comparative compound and a commercially available compound (see example 4) due to the significantly better cocoa butter/cocoa mass tolerance of the non-temper vegetable fat composition of the invention as disclosed herein.

One of the benefit for the producer of such edible application compounds is reduction of the risk of blooming of their edible applications compounds due to a to high content of cocoa butter and/or cocoa mass in their compound recipe (either deliberately added or via cross contamination on the production line).

In one or more embodiment of the edible application product, the vegetable fat composition or the vegetable fat mixture makes up from 50% to 100% by weight of the total fat phase in the edible application product, such as from 80% to 100% by weight, such as from 90% to 100% by weight, or such as around 95% by weight of the total fat phase in the edible application product.

In one or more embodiment of the edible application product, the vegetable fat composition or the vegetable fat mixture makes up from 10% to 70% by weight of the total fat phase in the edible application product, such as from 20% to 60% by weight, such as from 25% to 50% by weight, or such as from 28% to 40% by weight of the total edible application product.

The edible application product may be a bakery-, a dairy-, a chocolate-, and/or a chocolate-like product.

The edible application product may be a coating or enrobing product for bakery, confectionery, and/or molding applications.

The edible application product may be a filling, such as a bakery filling or a confectionery filling.

The edible application product may be a chocolate or chocolate-like coating.

In one or more embodiments, the edible application product comprises the vegetable fat composition according to the present disclosure and wherein the fat part of the edible application product comprises the following fatty acid characteristics:
a. the sum of saturated fatty acids (SAFA) is at least 90% by weight,
b. the sum of saturated C20 to C22 fatty acids is at least 13% by weight,
c. the sum of saturated C8 to C10 fatty acids is in the range from 2% to 15% by weight, and
d. the sum of saturated C12 to C14 fatty acids is at least 30% by weight.

In one or more embodiments, where the edible application product comprises the vegetable fat composition according to the present disclosure as disclosed above—the fat part of the edible application product further comprises the following fatty acid characteristics: the sum of saturated fatty acids is at least 92% by weight, such as at least 93% by weight, such as at least 95% by weight, such as at least 97% by weight, or such as at least 99% by weight.

In one or more embodiments, where the edible application product comprises the vegetable fat composition according to the present disclosure as disclosed above—the fat part of the edible application product further comprises the following fatty acid characteristics: the sum of saturated fatty acids is in the range from 90% to 100% by weight, such as in the range from 93% to 100%.

In one or more embodiments, where the edible application product comprises the vegetable fat composition according to the present disclosure as disclosed above—the fat part of the edible application product further comprises the following fatty acid characteristics: the sum of saturated C20 to C22 fatty acids is at least 14% by weight, such as at least 15% by weight, or such as at least 16% by weight.

In one or more embodiments, where the edible application product comprises the vegetable fat composition according to the present disclosure as disclosed above—the fat part of the edible application product further comprises the following fatty acid characteristics: the sum of saturated C20 to C22 fatty acids is in the range from 13% to 25% by weight, such as in the range from 13% to 22%.

In one or more embodiments, where the edible application product comprises the vegetable fat composition according to the present disclosure as disclosed above—the fat part of the edible application product further comprises the following fatty acid characteristics: the sum of saturated C8 to C10 fatty acids is in the range from 3% to 14% by weight, such as in the range from 4% and 13% by weight, such as in the range from 5% and 12% by weight, such as in the range from 6% and 11% by weight, or such as in the range from 7% and 10% by weight.

In one or more embodiments, where the edible application product comprises the vegetable fat composition according to the present disclosure as disclosed above—the fat part of the edible application product further comprises the following fatty acid characteristics: the sum of saturated C12 to C14 fatty acids is at least 35% by weight, such as at least 38% by weight.

In one or more embodiments, where the edible application product comprises the vegetable fat composition according to the present disclosure as disclosed above—the fat part of the edible application product further comprises the following fatty acid characteristics: the sum of saturated C12 to C14 fatty acids is in the range from 30% to 55% by weight, such as in the range from 35% to 50% by weight.

In one or more embodiments, where the edible application product comprises the vegetable fat composition according to the present disclosure as disclosed above—the fat part of the edible application product further comprises the following fatty acid characteristics: the sum of saturated C16 to C18 fatty acids is at least 20% by weight.

In one or more embodiments, where the edible application product comprises the vegetable fat composition according to the present disclosure as disclosed above—the fat part of the edible application product further comprises the following fatty acid characteristics: the sum of saturated C16 to C18 fatty acids is in the range from 20% to 45% by weight, such as in the range from 22% to 40% by weight.

When describing the embodiments, the combinations and permutations of all possible embodiments have not been explicitly described. Nevertheless, the mere fact that certain measures are recited in mutually different dependent claims or described in different embodiments does not indicate that a combination of these measures cannot be used to advantage. The present invention envisage all possible combinations and permutations of the described embodiments.

The present invention is further illustrated by the following examples, which are not to be construed as limiting the scope of protection.

### EXAMPLES

### Example 1—Robust Vegetable Fat Compositions

A number of vegetable fat compositions are produced via chemical inter esterification of vegetable oil components in an oil reaction mixture. This is a standard method. The following is one way of carrying out the method. The acid degree (° S) of the mixture are determined, and if the value is above 2, the mixture should be neutralised before heating the mixture to 125° C. for at least an hour under reduced pressure followed by cooling to the preferred temperature depending on the melting point of the mixture. After cooling the mixture, sodium methylate is added to the mixture and the mixture is mixed under vacuum for approximate 1 to 3 hours, followed by a PH neutralising step. The mixture is dried under vacuum and the mixture is bleached and filtered to yield the final vegetable fat composition. The oil reaction mixtures in this example are based on hydrogenated coconut oil, coconut oil, hydrogenated High Erucic Rapeseed (HEAR) oil, and hydrogenated rape seed oil. Table 1 displays the feed composition and the fatty acid composition as well as the solid fat content (SFC) profile and iodine values (IV) of the vegetable fat compositions.

TABLE 1
Feed compositions, FAC and SFC profiles on vegetable fat compositions.

| | | | | | | | G |
|---|---|---|---|---|---|---|---|
| | A | B | C | D | E | F | (comparative) |
| Vegetable fat composition | | | | | | | |
| Hydrogenated coconut | 75.0 | 70.0 | 65.0 | 60.0 | | | 65.0 |
| oil (% w/w) | | | | | | | |
| Coconut oil (% w/w) | | | | | 65.0 | 70.0 | |
| Hydrogenated high erucic | 25.0 | 30.0 | 35.0 | 40.0 | 35.0 | 30.0 | |
| rapeseed oil (% w/w) | | | | | | | |
| Hydrogenated rapeseed | | | | | | | 35.0 |
| oil (% w/w) | | | | | | | |
| Fatty acid composition | | | | | | | |
| C6:0 (% w/w) | 0.4 | 0.4 | 0.4 | 0.3 | 0.4 | 0.4 | 0.4 |
| C8:0 (% w/w) | 5.4 | 4.9 | 4.6 | 4.2 | 4.6 | 5.0 | 4.4 |
| C10:0 (% w/w) | 4.2 | 3.8 | 3.6 | 3.3 | 3.6 | 3.9 | 3.5 |
| C12:0 (% w/w) | 34.2 | 32.0 | 29.4 | 27.7 | 29.5 | 32.0 | 28.4 |
| C14:0 (% w/w) | 13.9 | 13.1 | 12.0 | 11.2 | 12.0 | 13.0 | 11.6 |
| C16:0 (% w/w) | 8.3 | 8.1 | 7.8 | 7.6 | 7.6 | 8.0 | 10.0 |
| C18:0 (% w/w) | 19.6 | 21.3 | 22.8 | 24.4 | 17.3 | 15.2 | 40.3 |
| C18:1 (% w/w) | | | | 0.1 | 4.3 | 4.8 | |
| C18:2 (% w/w) | | | | | 1.1 | 1.2 | |
| C20:0 (% w/w) | 2.5 | 2.9 | 3.4 | 3.6 | 3.4 | 2.8 | 0.8 |
| C22:0 (% w/w) | 11.2 | 13.2 | 15.6 | 17.1 | 15.8 | 13.2 | 0.4 |
| C24:0 (% w/w) | 0.3 | 0.4 | 0.4 | 0.4 | 0.4 | 0.3 | 0.1 |
| SAFA (% w/w) | 100.0 | 100.0 | 100.0 | 99.8 | 94.6 | 93.7 | 99.9 |
| Sum C20:0 + C22:0 (% w/w) | 13.7 | 16.1 | 19.0 | 20.7 | 19.2 | 16.0 | 1.2 |
| Sum C8:0 + C10:0 (% w/w) | 9.6 | 8.7 | 8.2 | 7.5 | 8.2 | 8.9 | 7.9 |
| Sum C12:0 + C14:0 (% w/w) | 48.1 | 45.1 | 41.4 | 38.9 | 41.5 | 45.0 | 40.0 |
| Solid fat content (SFC) | | | | | | | |
| SFC (20° C.) | 74.4 | 73.4 | 78.9 | 78.1 | 67.4 | 64.1 | 79.4 |
| SFC (25° C.) | 58.7 | 58.8 | 66.4 | 64.6 | 52.8 | 48.3 | 67.9 |
| SFC (30° C.) | 32.5 | 35.9 | 45.5 | 48.8 | 31.3 | 24.5 | 49.3 |
| SFC (35° C.) | 11.1 | 15.5 | 23.4 | 28.0 | 13.3 | 8.3 | 26.3 |
| SFC (40° C.) | 1.9 | 3.8 | 8.1 | 11.2 | 3.6 | 1.1 | 11.6 |
| IV value | 0.0 | 0.0 | 0.0 | 0.1 | 5.6 | 6.2 | 0.0 |

The fatty acid compositions of the vegetable fat compositions were analyzed using IUPAC 2.301 (Methylation) and IUPAC 2.304 (GLC). The solid fat content (SFC) was measured according to IUPAC 2.150a. The iodine value (IV) was measured according to IUPAC 2.205.

### Example 2—Vegetable Fat Mixtures of Vegetable Fat Compositions from Table 1 and Fully Hydrogenated Palm Kernel Stearin IV 7

Table 2 displays the blend component composition as well as the solid fat content (SFC) profile of vegetable fat mixtures. Furthermore, a commercially available CBS is present as comparative example H0. The ‘fully hydrogenated PKS IV 7’ in the table is a Palm Kernel Stearin (PKS) with an iodine value of 7 (IV 7) that is fully hydrogenated.

TABLE 2
Blend compositions and SFC profiles for fat mixtures.

| | | | | | | | H0 |
|---|---|---|---|---|---|---|---|
| | | | | | | G0 | (comparative) |
| | A0 | B0 | C0 | D0 | E0 | (comparative) | standard CBS |
| Vegetable Fat Mixture | | | | | | | |
| Vegetable fat | 40.0 | | | | | | |
| composition A (% w/w) | | | | | | | |
| Vegetable fat | | 30.0 | | | | | |
| composition B (% w/w) | | | | | | | |
| Vegetable fat | | | 35.0 | | | | |
| composition C (% w/w) | | | | | | | |
| Vegetable fat | | | | 50.0 | | | |
| composition D (% w/w) | | | | | | | |
| Vegetable fat | | | | | 35.0 | | |
| composition E (% w/w) | | | | | | | |
| Vegetable fat | | | | | | 30.0 | |
| composition G (% w/w) | | | | | | | |
| Fully hydrogenated | 58.0 | 68.0 | 63.0 | 48.0 | 63.0 | 68.0 | 98.0 |
| PKS IV 7 (% w/w) | | | | | | | |
| Sorbitan tristearate | 2.0 | 2.0 | 2.0 | 2.0 | 2.0 | 2.0 | 2.0 |
| (STS) (% w/w) | | | | | | | |
| Solid fat content (SFC) | | | | | | | |
| SFC (20° C.) | 88.8 | 92.2 | 91.1 | 79.3 | 88.0 | 93.6 | 95.0 |
| SFC (25° C.) | 66.4 | 72.4 | 72.9 | 55.7 | 66.9 | 76.6 | 87.6 |
| SFC (30° C.) | 28.6 | 31.1 | 33.9 | 19.7 | 28.1 | 37.2 | 45.3 |
| SFC (35° C.) | 4.1 | 4.8 | 6.9 | 6.8 | 4.5 | 8.8 | 3.2 |
| SFC (40° C.) | <0.5 | <0.5 | 0.7 | 2.1 | <0.5 | 2.0 | <0.5 |

All vegetable fat mixtures of the invention (A0, B0, C0, D0 and E0) apart from D0 have SFC values at 20° C. above 85 and SFC values at 40° C. of around or less than 0.5. From an SFC melt profile point of view all the vegetable fat mixtures show potential for use as compound vegetable fat in molding and coating/enrobing compound applications.

### Example 3—Recipes and Manufacture of Dark Compounds

Table 3 displays the recipes for the dark compound used.

TABLE 3
Composition of dark compounds.

| | 1 | 2 |
|---|---|---|
| | (10% CB) | (15% CB) |
| Dark compound recipes | | |
| Vegetable fat mixture (% w/w) | 28.5 | 26.8 |
| Cocoa Mass (56% CB) (% w/w) | 3.2 | 6.4 |
| Cocoa powder (10-12% CB) (% w/w) | 13.3 | 11.8 |
| Sugar (% w/w) | 48.6 | 48.6 |
| Skim milk powder (% w/w) | 6.0 | 6.0 |
| Lecithin | 0.4 | 0.4 |
| Total fat content (% w/w) | 31.8 | 31.8 |
| The fat composition distribution in the recipe | | |
| Vegetable fat (% w/w) | 89.6 | 84.5 |
| Cocoa butter (% w/w) | 10.2 | 15.3 |
| Milk fat (% w/w) | 0.2 | 0.2 |

Two different dark compound compositions based on the vegetable fat mixtures in table 2 are illustrated in table 3.

All the ingredients for the dark compounds were mixed in a Hobart N-50 mixer at 65° C. for ten minutes and refined in a Bühler SDY-300 three-roll refiner to a particle size of approximately 20μ. Thereafter, the dark compounds were conched in the Hobart mixer for 6 hours at 65° C. The compounds were subsequently deposited into 50 g tablet molds and used for coatings on biscuits. Both applications were cooled in three zone cooling tunnel for 30 minutes at a temperature of 6° C. for 20 minutes followed by a temperature of 15° C. for 10 minutes.

### Example 4—Shelf Life

The molded 50 grams bars and enrobed biscuits were stored at 20° C. for one week and then inserted into temperature-controlled cabinets for consequent shelf life evaluation at 15, 20, and 23° C. isotherm, respectively. Table 4 illustrate the time in weeks for the first appearance of bloom on the surface of the 50 gram bars and the enrobed biscuits stored at the different storage conditions. The shelf life results from compounds based on the vegetable fat mixtures in example 2, are illustrated in table 4 and 5.

TABLE 4
Shelf life for dark compound with 10%
cocoa butter in fat composition.

| Dark compounds | | | |
|---|---|---|---|
| B01 | E01 | G01 | H01 |
| Dark compound recipe | | | |
| 1 | 1 | 1 | 1 |
| Vegetable Fat Mixture | | | |
| | | | H0 |
| | | G0 | (comparative) |
| C0 | E0 | (comparative) | standard CBS |

Weeks

| | | | | |
|---|---|---|---|---|
| 50 gram tablets | | | | |
| 15° C. | >26 | >26 | 13 | 8 |
| 20° C. | >26 | >26 | 8 | 15 |
| 23° C. | >26 | >26 | 18 | 20 |
| Enrobed biscuits | | | | |
| 15° C. | >26 | >26 | 4 | 12 |
| 20° C. | >26 | >26 | 4 | 15 |
| 23° C. | >26 | >26 | 4 | 18 |

The shelf life results clearly demonstrate that the compounds of the invention (B01 and E01) do not bloom even after 26 weeks at all three temperatures. This is on contrast to the comparative compound (G01) which display bloom on both tablets and enrobed biscuits at all temperatures within 18 weeks. The commercially available compound (H01) display bloom at 15° C. within 8 and 12 weeks for tablet and enrobed biscuits, respectively, while displaying bloom at 20 and 23° C. within 20 weeks.

TABLE 5
Shelf life for dark compound with 15% cocoa butter in fat composition.

| | Dark compounds | | | | | | |
|---|---|---|---|---|---|---|---|
| | A02 | B02 | C02 | D02 | E02 | G02 | H02 |
| | Dark compound recipe | | | | | | |
| | 2 | 2 | 2 | 2 | 2 | 2 | 2 |
| | Vegetable Fat Mixture | | | | | | |
| | | | | | | | H0 |
| | | | | | | G0 | (comparative) |
| | A0 | B0 | C0 | D0 | E0 | (comparative) | standard CBS |
| 15° C. | 13 | 17 | 20 | 15 | 18 | 11 | 4 |
| 20° C. | >40 | 33 | >26 | 35 | >26 | 11 | 7 |
| 23° C. | >40 | >40 | >26 | >40 | >26 | 14 | 18 |
| Enrobed biscuits | | | | | | | |
| 15° C. | 13 | 16 | 20 | 16 | 14 | 4 | 3 |
| 20° C. | >40 | 30 | >26 | 34 | >26 | 4 | 3 |
| 23° C. | >40 | >40 | >26 | >40 | >26 | 8 | 14 |

The shelf life results clearly demonstrate that the compounds of the invention (A02, B02, C02, D02 and E02) do not bloom even after 26 weeks at 20 and 23° C. These observations are in contrast to the shelf life for both the comparative compound (G02) and commercially available compounds (H02) which display bloom on both tablets and enrobed biscuits within 18 weeks or less at 20 and 23° C.

For all the compounds of the invention with 15% cocoa butter in fat composition bloom is evident on both tablets and enrobed biscuits between 13 and 20 weeks at 15° C. For the comparative and commercial compounds bloom is evident on both tablets and enrobed biscuits between 3 and 11 weeks at 15° C. Thus, at 15° C. the shelf life is extended for the compounds of the invention as compared to the comparative compounds.

The invention is further described in the following non-limiting items.
1. A vegetable fat composition for edible applications, wherein the triglycerides in said vegetable fat composition contain randomly distributed fatty acids, and wherein, in said vegetable fat composition the:
   a. sum of saturated fatty acids (SAFA) is at least 90% by weight,
   b. sum of saturated C20 to C22 fatty acids is at least 13% by weight,
   c. sum of saturated C8 to C10 fatty acids is in the range from 2% to 15% by weight, and
   d. sum of saturated C12 to C14 fatty acids is at least 30% by weight.
2. The vegetable fat composition according to item 1, wherein the sum of saturated fatty acids is at least 92% by weight, such as at least 93% by weight, such as at least 95% by weight, such as at least 97% by weight, or such as at least 99% by weight.
3. The vegetable fat composition according to item 1 or 2, wherein the sum of saturated fatty acids is in the range from 90% to 100% by weight, such as in the range from 93% to 100%.
4. The vegetable fat composition according to any of the preceding items, wherein the sum of saturated C20 to C22 fatty acids is at least 14% by weight, such as at least 15% by weight, or such as at least 16% by weight.
5. The vegetable fat composition according to any of the preceding items, wherein the sum of saturated C20 to C22 fatty acids is in the range from 13% to 25% by weight, such as in the range from 13% to 22%.
6. The vegetable fat composition according to any of the preceding items, wherein the sum of saturated C8 to C10 fatty acids is in the range from 3% to 14% by weight, such as in the range from 4% and 13% by weight, such as in the range from 5% and 12% by weight, such as in the range from 6% and 11% by weight, or such as in the range from 7% and 10% by weight.
7. The vegetable fat composition according to any of the preceding items, wherein the sum of saturated C12 to C14 fatty acids is at least 35% by weight, such as at least 38% by weight.
8. The vegetable fat composition according to any of the preceding items, wherein the sum of saturated C12 to C14 fatty acids is in the range from 30% to 55% by weight, such as in the range from 35% to 50% by weight.
9. The vegetable fat composition according to any of the preceding items, wherein the sum of saturated C16 to C18 fatty acids is at least 20% by weight.
10. The vegetable fat composition according to any of the preceding items, wherein the sum of saturated C16 to C18 fatty acids is in the range from 20% to 45% by weight, such as in the range from 22% to 40% by weight.
11. The vegetable fat composition according to any of the preceding items, wherein the iodine value (IV) of the vegetable fat composition is no more than 4.4.
12. The vegetable fat composition according to any of the preceding items, wherein the iodine value (IV) of the vegetable fat composition is in the range of 0.0 to 4.4.
13. The vegetable fat composition according to any of the preceding items, wherein the randomly distributed fatty acids in said vegetable fat composition is obtained by esterification of glycerol with free fatty acids.
14. The vegetable fat composition according to any of items 1 to 12, wherein the randomly distributed fatty acids in said vegetable fat composition is obtained by an interesterification or a transesterification of vegetable oil parts, such as a chemically interesterification of vegetable oil parts.
15. Use of a vegetable fat composition for manufacturing of a vegetable fat mixture, wherein the vegetable fat mixture comprises a blend of a vegetable fat composition selected from a vegetable fat composition according to any of items 1 to 14 and at least one vegetable fat component.
16. The use of a vegetable fat composition for manufacturing of a vegetable fat mixture according to item 15, wherein the at least one vegetable fat component is selected from the group consisting of palm kernel oil, coconut oil, high lauric rapeseed oil, or a blend thereof, and/or fractions thereof, or an interesterified, fractionated, and/or hydrogenated version of palm kernel oil, coconut oil, high lauric rapeseed oil, or a blend thereof, and/or fractions thereof.
17. The use of a vegetable fat composition for manufacturing of a vegetable fat mixture according to any of item 15 or 16 wherein the vegetable fat mixture is a cocoa butter substitute (CBS).
18. A vegetable fat mixture comprising a vegetable fat composition according to any of items 1-14 in the amount from 10% to 70% by weight, such as from 20% to 60% by weight, or such as from 25% to 45% by weight and at least one vegetable fat component.
19. The vegetable fat mixture according to item 18, wherein the vegetable fat mixture is a CBS.
20. The vegetable fat mixture according to item 18 or 19, wherein the at least one vegetable fat component is selected from the group consisting of palm kernel oil, coconut oil, high lauric rapeseed oil, or a blend thereof and/or fractions thereof, or an interesterified, fractionated, and/or hydrogenated version of palm kernel oil, coconut oil, high lauric rapeseed oil, or a blend thereof and/or fractions thereof.
21. The vegetable fat mixture according to any of items 18 to 20, wherein the solid fat content (SFC) at 20° C. is above 70, such as above 75, such as above 80, or such as above 85.
22. The vegetable fat mixture according to any of items 18 to 21, wherein the SFC at 40° C. is less than 2.5, such as less than 2.0, such as less than 1.5, such as less than 1.0, or such as less than 0.5.
23. Use of the vegetable fat mixture according to any of items 18 to 22 in coating or enrobing for bakery, confectionery, and/or molding applications.
24. Use of the vegetable fat mixture according to any of items 18 to 22 in fillings, such as bakery fillings and confectionery fillings.
25. Use of the vegetable fat mixture according to any of items 18 to 22 for chocolate and chocolate-like coatings.
26. An edible application product comprising the vegetable fat composition according to any of item 1 to 14 or the vegetable fat mixture according to any of item 18 to 22.
27. The edible application product according to item 26, wherein the vegetable fat composition or the vegetable fat mixture makes up from 50% to 100% by weight of the total fat phase in the edible application product, such as from 80% to 100% by weight, such as from 90% to 100% by weight, or such as around 95% by weight of the total fat phase in the edible application product.
28. The edible application product according to item 26, wherein the vegetable fat composition or the vegetable fat mixture makes up from 10% to 70% by weight of the total fat phase in the edible application product, such as from 20% to 60% by weight, such as from 25% to 50% by weight, or such as from 28% to 40% by weight of the total edible application product.
29. The edible application product according to any of items 26 to 28, wherein said edible application is a bakery-, a dairy-, a chocolate-, and/or a chocolate-like product.
30. The edible application product according to any of items 26 to 28, wherein the edible application product is a coating or enrobing product for bakery, confectionery, and/or moulding applications.
31. The edible application product according to any of items 26 to 28, wherein the edible application product is a filling, such as a bakery filling or a confectionery filling.
32. The edible application product according to any of items 26 to 28, wherein the edible application product is a chocolate or chocolate-like coating.
33. The edible application product according to any of items 26 to 32, comprising the vegetable fat composition according to any of items 1 to 14 and wherein the fat part of the edible application product comprises the following fatty acid characteristics:
   a. the sum of saturated fatty acids (SAFA) is at least 90% by weight,
   b. the sum of saturated C20 to C22 fatty acids is at least 13% by weight,
   c. the sum of saturated C8 to C10 fatty acids is in the range from 2% to 15% by weight, and
   d. the sum of saturated C12 to C14 fatty acids is at least 30% by weight.
34. The edible application product according to item 33, wherein the sum of saturated fatty acids is at least 92% by weight, such as at least 93% by weight, such as at least 95% by weight, such as at least 97% by weight, or such as at least 99% by weight.
35. The edible application product according to item 33 or 34, wherein the sum of saturated fatty acids is in the range from 90% to 100% by weight, such as in the range from 93% to 100%.
36. The edible application product according to any of items 33 to 35, wherein the sum of saturated C20 to C22 fatty acids is at least 14% by weight, such as at least 15% by weight, or such as at least 16% by weight.
37. The edible application product according to any of items 33 to 35, wherein the sum of saturated C20 to C22 fatty acids is in the range from 13% to 25% by weight, such as in the range from 13% to 22%.
38. The edible application product according to any of items 33 to 37, wherein the sum of saturated C8 to C10 fatty acids is in the range from 3% to 14% by weight, such as in the range from 4% and 13% by weight, such as in the range from 5% and 12% by weight, such as in the range from 6% and 11% by weight, or such as in the range from 7% and 10% by weight.
39. The edible application product according to any of items 33 to 38, wherein the sum of saturated C12 to C14 fatty acids is at least 35% by weight, such as at least 38% by weight.
40. The edible application product according to any of items 33 to 38, wherein the sum of saturated C12 to C14 fatty acids is in the range from 30% to 55% by weight, such as in the range from 35% to 50% by weight.
41. The edible application product according to any of items 33 to 40, wherein the sum of saturated C16 to C18 fatty acids is at least 20% by weight.
42. The edible application product according to any of items 33 to 41, wherein the sum of saturated C16 to C18 fatty acids is in the range from 20% to 45% by weight, such as in the range from 22% to 40% by weight.

1. A vegetable fat composition for edible applications comprising:
triglycerides, wherein said triglycerides comprise randomly distributed fatty acids; and wherein, in said vegetable fat composition, the:
a. sum of saturated fatty acids (SAFA) is at least 90% by weight,
b. sum of saturated C20 to C22 fatty acids is at least 13% by weight,
c. sum of saturated C8 to C10 fatty acids is in the range from 2% to 15% by weight, and
d. sum of saturated C12 to C14 fatty acids is at least 30% by weight.

2. The vegetable fat composition according to claim 1, wherein the sum of saturated fatty acids is at least 92% by weight.

3. The vegetable fat composition according to claim 1, wherein the sum of saturated C20 to C22 fatty acids is at least 14% by weight.

4. The vegetable fat composition according to claim 1, wherein the sum of saturated C8 to C10 fatty acids is in the range from 3% to 14% by weight.

5. The vegetable fat composition according to claim 1, wherein the sum of saturated C12 to C14 fatty acids is at least 35% by weight.

6. The vegetable fat composition according to claim 1, wherein the sum of saturated C16 to C18 fatty acids is at least 20% by weight.

7. The vegetable fat composition according to claim 1, wherein the iodine value (IV) of the vegetable fat composition is no more than 4.4.

8. The vegetable fat composition according to claim 1, wherein the randomly distributed fatty acids in said vegetable fat composition are obtained by esterification of glycerol with free fatty acids.

9. The vegetable fat composition according to claim 1, wherein the randomly distributed fatty acids in said vegetable fat composition are obtained by an interesterification or a transesterification of vegetable oil parts.

10. A vegetable fat composition for manufacturing of a vegetable fat mixture, wherein the vegetable fat mixture comprises a blend of a vegetable fat composition according to claim 1 and at least one vegetable fat component.

11. The vegetable fat composition according to claim 10, wherein the at least one vegetable fat component is selected from the group consisting of palm kernel oil, coconut oil, high lauric rapeseed oil, or a blend thereof, and/or fractions thereof, or an interesterified, fractionated, and/or hydrogenated version of palm kernel oil, coconut oil, high lauric rapeseed oil, or a blend thereof, and/or fractions thereof.

12. The vegetable fat composition according to claim 10, wherein the vegetable fat mixture is a cocoa butter substitute (CBS).

13. A vegetable fat mixture comprising a vegetable fat composition according to claim 1 in the amount from 10% to 70% by weight and at least one vegetable fat component.

14. The vegetable fat mixture according to claim 13, wherein the vegetable fat mixture is a CBS.

15. The vegetable fat mixture according to claim 13, wherein the at least one vegetable fat component is selected from the group consisting of palm kernel oil, coconut oil, high lauric rapeseed oil, or a blend thereof and/or fractions thereof, or an interesterified, fractionated, and/or hydrogenated version of palm kernel oil, coconut oil, high lauric rapeseed oil, or a blend thereof and/or fractions thereof.

16. (canceled)

17. An edible application product comprising the vegetable fat composition according to claim 1.

18. An edible application product comprising the vegetable fat mixture according to claim 13.
